(19) United States
(12) Patent Application Publication
(10) Pub. No.: US 2015/0294339 A1
(43) Pub. Date: Oct. 15, 2015

(54) System for Secure Transactions

(71) Applicant: Bank of America Corporation, Charlotte, NC (US)

(72) Inventors: Angel A. Vargas, Charlotte, NC (US); Bridget E. O'Connor, Holmdel, NJ (US)

(73) Assignee: Bank of America Corporation, Charlotte, NC (US)

(21) Appl. No.: 14/250,122

(22) Filed: Apr. 10, 2014

(51) Int. Cl. G06Q 30/02; G06Q 20/40

(52) U.S. Cl. CPC G06Q 30/0215; G06Q 20/405

(57) ABSTRACT

In some embodiments, a system comprises an interface and one or more processors. The interface receives account information associated with a financial account, wherein the financial account corresponds to a consumer. The processors are communicatively coupled to the interface. The processors determine, based on the account information, that the consumer invoked one or more security features for the financial account. The processors determine a reward based on the security features that the consumer invoked for the financial account and apply the reward to the financial account.

### TECHNICAL FIELD OF THE INVENTION

This invention relates generally to risk and fraud mitigation, and more particularly to a system for secure transactions.

### BACKGROUND

Enterprises and financial institutions perform transactions on behalf of users and customers. Before authorizing a transaction, such as a credit card purchase, enterprises and financial institutions may perform analysis to detect potentially fraudulent transactions. Such analysis may include examining a user's past transaction history to make predictions about a current transaction. Making such predictions may consume computing resources and the resulting prediction may not be accurate.

### SUMMARY

In some embodiments, a system comprises an interface and one or more processors. The interface receives account information associated with a financial account, wherein the financial account corresponds to a consumer. The processors are communicatively coupled to the interface. The processors determine, based on the account information, that the consumer invoked one or more security features for the financial account. The processors determine a reward based on the security features that the consumer invoked for the financial account and apply the reward to the financial account.

Certain embodiments of the present disclosure may provide one or more technical advantages. A technical advantage of one embodiment includes reducing an amount of computing resources used for fraud detection. Encouraging a consumer to be security conscious may reduce a need to track consumer patterns to predict potentially fraudulent transactions. Another technical advantage of an embodiment includes increased accuracy in fraud detection through a consumer's proactive indication of spending patterns.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an example block diagram of a system for secure transactions, according to a particular embodiment;

FIG. 2 illustrates an example user interface for configuring a security profile, according to a particular embodiment;

FIG. 3 illustrates an example flowchart of a method for incentivizing secure transactions, according to a particular embodiment; and

FIG. 4 illustrates another example flowchart of a method for incentivizing secure transactions, according to a particular embodiment.

### DETAILED DESCRIPTION OF THE DRAWINGS

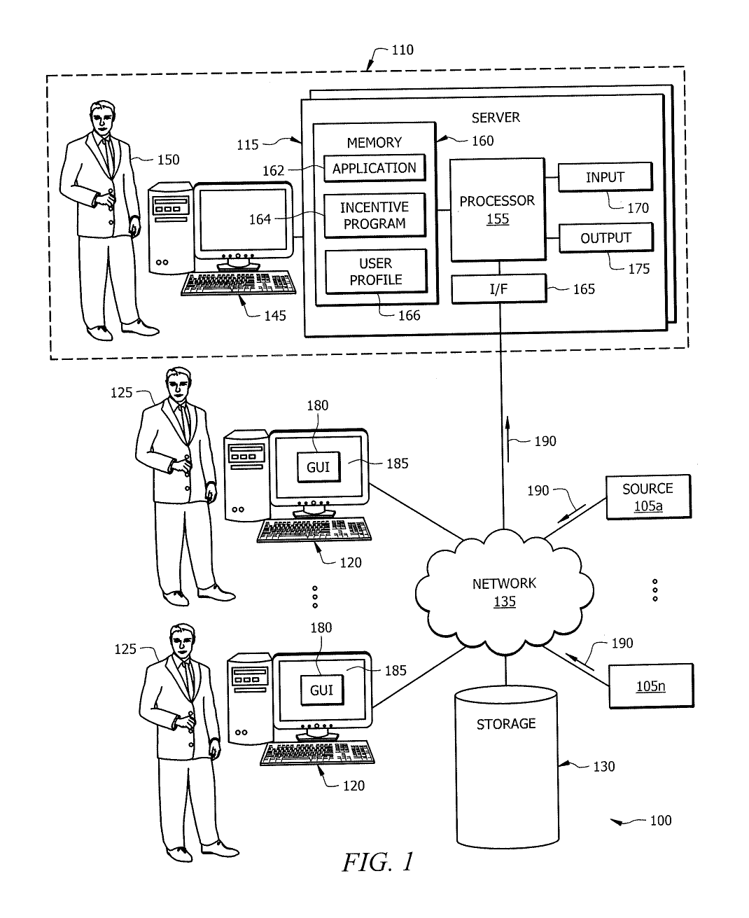

Embodiments of the present invention and its advantages are best understood by referring to FIGS. 1 through 4 of the drawings, like numerals being used for like and corresponding parts of the various drawings.

Enterprises, financial institutions, and other entities that conduct transactions with customers may perform fraud detection to verify the authenticity of a transaction. Examples of such transactions may include credit card purchases, debit card purchases, withdrawing funds, transferring funds, or any other suitable transaction. Particular embodiments reward consumers that use financial products in a responsible and secure manner. Rewarding consumers may increase the usage of security features and, thus, may be an efficient method of preventing fraudulent transactions.

Conventional techniques for detecting fraudulent transactions may rely on analysis of a consumer's transaction history to predict the authenticity of a current transaction. These conventional techniques may tend to guess what is unusual for a particular consumer based on that consumer's transaction history. This guesswork may cause certain potentially fraudulent transactions to go undetected. Even if a potentially fraudulent transaction is detected, conventional techniques may only alert a consumer of the potentially fraudulent transaction instead of denying the transaction. Consumers may become dissatisfied with alerts based on inaccurate predictions, or consumers may not be motivated to respond to an alert.

To address this and other problems, embodiments of the present invention encourage a consumer to take advantage of security features such as specification of transaction limits, advance notification of travel, use of personal identification numbers at retail point of sale transactions, use of temporary card numbers for online transactions, and any other suitable security feature. Such encouragement may include offering a consumer certain rewards based on the consumer's use of security features. In some embodiments, the consumer may use the security features to indicate transactions that the particular consumer would not typically make, such as transactions over a certain dollar amount, transactions with a certain type of vendor, or transactions via certain channels (such as Internet transactions). The consumer's input may be used to tailor fraud detection techniques according to the particular consumer, which may allow for more accurate fraud detection.

FIG. 1 illustrates an example block diagram of a system 100 for secure transactions, according to a particular embodiment. System 100 may include one or more transaction sources 105, an enterprise 110 comprising one or more servers 115, one or more clients 120 associated with one or more users 125, and a network storage device 130. Transaction sources 105, enterprise 110, servers 115, clients 120, and network storage device 130 may be communicatively coupled by a network 135. In general, transaction source 105 may provide a server 115 of enterprise 110 with transaction information 190 associated with a transaction.

Transaction source 105 may refer to any system, process, or tool that communicates transaction information 190 to server 115 and system 100 may comprise any number or combination of transaction sources 105. Server 115 may analyze transaction information 190 to determine a security level associated with the transaction. Based on the determined security level, server 115 may determine a reward value associated with one or more transactions.

Transaction information 190 may include transaction number, account number, originating party identifier, beneficiary party identifier, transaction date, transaction location, transaction method (e.g., bank branch, ATM, online, wire, cash, etc.), transaction type (e.g., deposit, withdrawal, transfer), dollar amount, report indicator that indicates whether or not a report was filed on the transaction, security indicator that indicates whether point of sale security measures were used (e.g., personal identification number, temporary or one-time account identifier), and/or other suitable information.

In some embodiments, enterprise 110 may refer to a financial institution such as a bank and may include one or more servers 115, an administrator workstation 145, and an administrator 150. In some embodiments, server 115 may refer to any suitable combination of hardware and/or software implemented in one or more modules to process data and provide the described functions and operations. In some embodiments, the functions and operations described herein may be performed by a pool of servers 115. For example, one server 115 may determine a security level associated with one or more transactions. Another server 115 operable to administer reward programs may correlate a determined security level with a reward value. In some embodiments, server 115 may include, for example, a mainframe, server, host computer, workstation, web server, file server, a personal computer such as a laptop, or any other suitable device operable to process data. In some embodiments, server 115 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, server 115 analyzes transaction information 190 to determine a security level associated with a transaction, synthesizes security levels associated with one or more transactions into a reward value, and applies the reward value to an incentive program associated with a consumer party to the transaction. In some embodiments, servers 115 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Although FIG. 1 illustrates server memory 160 as internal to server 115, server memory 160 may be internal or external to server 115, depending on particular implementations. Also, server memory 160 may be separate from or integral to other memory devices to achieve any suitable arrangement of memory devices for use in system 100.

Server memory 160 is generally operable to store an application 162, incentive programs 164, and user profiles 166. Application 162 generally refers to logic, rules, algorithms, code, tables, and/or other suitable instructions for performing the described functions and operations. In some embodiments, application 162 facilitates analyzing transaction information 190. Application 162 may facilitate determining a security level associated with the transaction and calculating a reward value. Such determinations and calculations may be based on information stored in user profile 166. Application 162 may facilitate applying the calculated reward value to an incentive program 164 that is associated with a consumer party to the transaction.

Incentive program 164 represents any suitable set of instructions, logic, or code embodied in a computer readable storage medium and operable to administer incentive programs, such as consumer reward programs associated with use of a financial product. In the following description, incentive program 164 may refer to the instructions, logic, or code operable to administer one or more incentive programs or incentive program 164 may interchangeably refer to a particular incentive program.

In particular embodiments, incentive programs 164 may include point programs where a consumer, such as user 125, earns points for certain transactions and the consumer, such as user 125, may redeem the points for something of value. For example, incentive program 164 may include an airline points program where user 125 receives a specified number of points for every dollar spent and the earned points are redeemable for airline miles. Incentive programs 164 may include cash back programs where user 125 receives a refund of some percentage of the total transaction amount transacted by user 125. The percentage may be variable and may correlate with transaction amount or any other suitable activity. In particular embodiments, an incentive reward may be a lowered interest rate applied to a consumer's account balance. In particular embodiments, incentive program 164 may include a security reward program where user 125 receives points for taking security measures associated with a transaction. In particular embodiments, incentive program 164 may include any combination of suitable incentive programs 164.

In particular embodiments, a security reward program may comprise an incentive program 164 where user 125 receives points for taking security measures and user 125 may redeem the points for something of value. For example, user 125 may register for a security reward program, agree to abide by certain security guidelines or use certain security features, and receive reward points for all transactions. In particular embodiments, user 125 may receive more or less points depending on how frequently user 125 takes advantage of available security features.

In particular embodiments, a security reward program may comprise a part of another incentive program 164. For example, an airline points program may include a security multiplier where a user 125 who chooses to engage in a secure transaction may receive more points than if user 125 had engaged in the same transaction without using security measures. For example, user 125 may earn 50 points for purchasing a $50 sweater from an online retailer. If user 125 chooses to use a temporary credit card account number (e.g., ShopSafe) when purchasing the sweater, user 125 may earn three times the points (150 points) for engaging in a highly secure transaction. Some security measures may be considered more secure (higher security level) than others and point multipliers may vary depending on a security level associated with a transaction.

In particular embodiments, a number of reward points or a point multiplier may be associated with a density of secure transactions instead of an individual transaction. For example, user 125 may be assigned to a security tier based on a number of secure transactions engaged in by user 125. User 125 who averages more secure transactions or transactions with a higher security level may be assigned to a higher security tier. A higher security tier may correlate to more earned points or a higher point multiplier.

User profile 166 represents any suitable set of instructions, logic, or code embodied in a computer readable storage medium and operable to associate user information with a consumer, such as user 125. In the following description, user profile 166 may refer to the instructions, logic, or code operable to associate user information with a consumer or user profile 166 may interchangeably refer to a particular user profile.

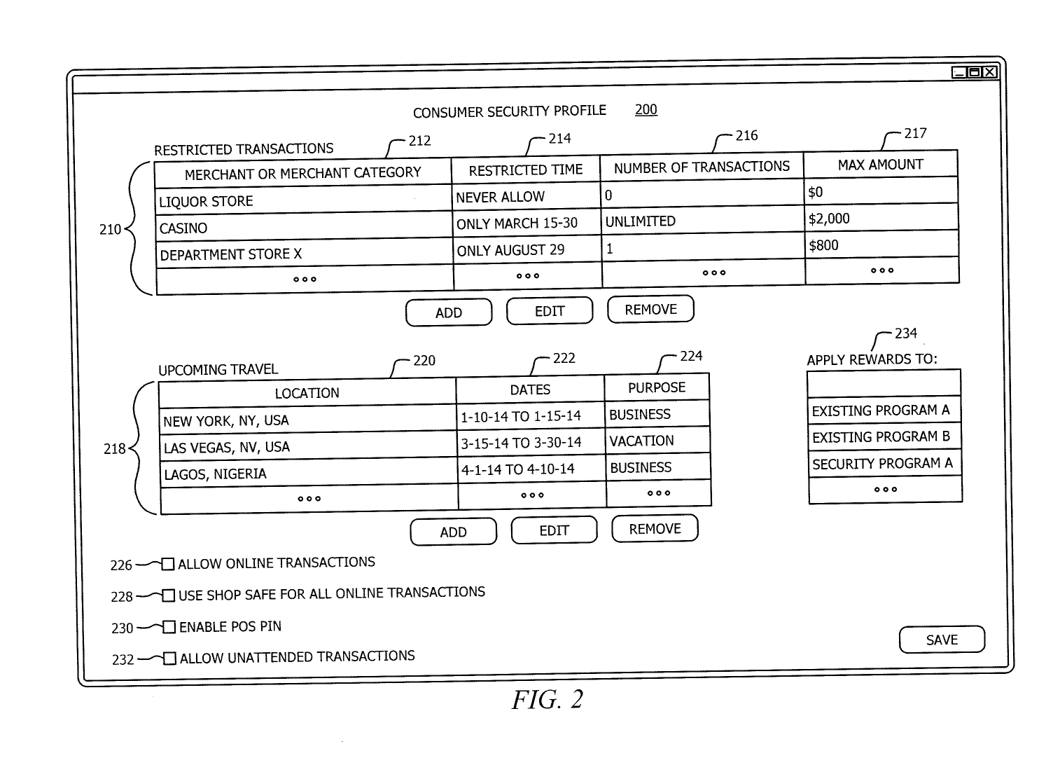

In particular embodiments, user profile 166 may maintain administrative information (e.g., name, billing address, contact information, etc.) and data related to the account (e.g., account number, type of account, account balance, account history, etc.). User profile 166 may maintain information about reward programs subscribed to by a consumer, such as user 125. User profile 166 may maintain information about security measures associated with a consumer's account. An interface for configuring security information associated with a particular user profile 166 is described in more detail with reference to FIG. 2 below.

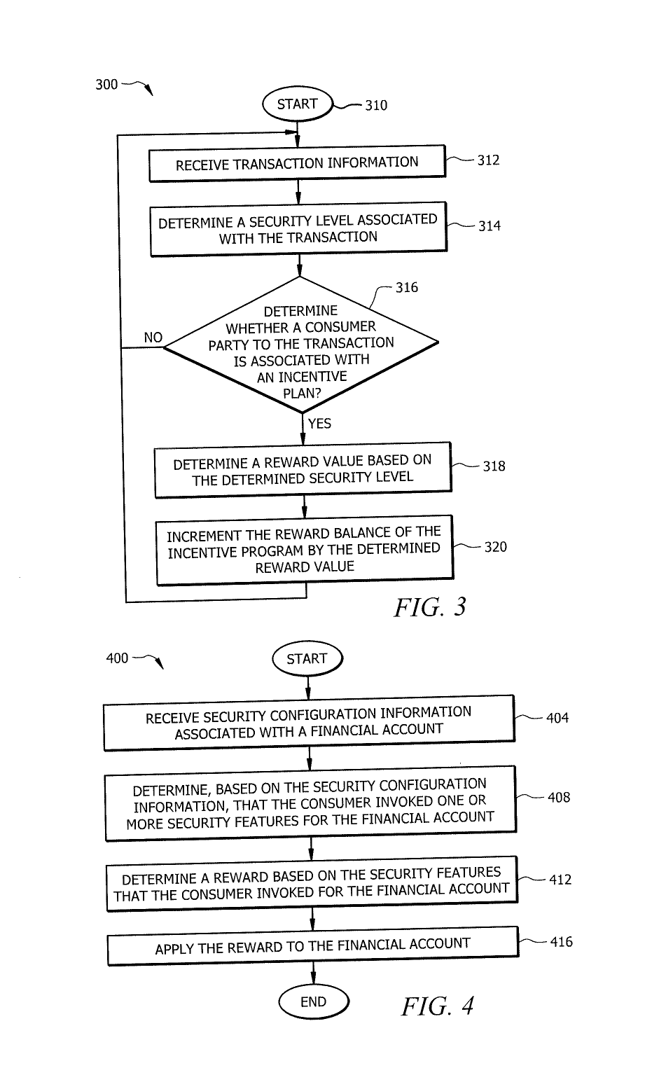

Server memory 160 communicatively couples to processor 155. Processor 155 is generally operable to execute application 162 stored in server memory 160 to incentivize secure transactions according to the disclosure. Processor 155 may comprise any suitable combination of hardware and software implemented in one or more modules to execute instructions and manipulate data to perform the described functions for servers 115. Examples of modules may include a security feature detection module that uses account information (such as transaction information and/or user profile information) to determine the security features that the consumer invoked for the financial account; a reward determination module for determining a reward based on the security features that the consumer invoked for the financial account; and a reward application module that may determine how to apply the reward to the financial account and/or communicate instructions for applying the reward. The modules may be integrated or separated and may be used to perform the methods described with respect to FIGS. 3 and 4 below. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for server 115, send output from server 115, perform suitable processing of the input or output or both, communicate to other devices, or any combination of the preceding. Communication interface 165 may include appropriate hardware (e.g. modem, network interface card, etc.) and software, including protocol conversion and data processing capabilities, to communicate through network 135 or other communication system that allows server 115 to communicate to other devices. Communication interface 165 may include any suitable software operable to access data from various devices such as clients 120 and/or network storage device 130. Communication interface 165 may also include any suitable software operable to transmit data to various devices such as clients 120 and/or network storage device 130. Communication interface 165 may include one or more ports, conversion software, or both. In general, communication interface 165 receives transaction information 190 from transaction source 105.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with server 115 using an administrator workstation 145. In some embodiments, administrator workstation 145 may be communicatively coupled to server 115 and may refer to any suitable computing system, workstation, personal computer such as a laptop, or any other device operable to process data. In certain embodiments, an administrator 150 may utilize administrator workstation 145 to manage server 115 and any of the data stored in server memory 160 and/or network storage device 130.

Client 120 may refer to any device that enables user 125 to interact with server 115. In some embodiments, client 120 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 120 may also comprise any suitable user interface such as a display 185, microphone, keyboard, or any other appropriate terminal equipment usable by a user 125. System 100 may comprise any number and combination of clients 120. User 125 may use client 120 to interact with server 115 to configure one or more user profiles 166, including security and/or incentive program parameters associated with user profiles 166 or user 125. In some embodiments, user 125 may be a consumer. In some embodiments, user 125 may be an employee of an enterprise or a financial institution. As an example, a bank teller may receive instructions from the consumer to configure certain security features on behalf of the consumer.

In some embodiments, client 120 may include a graphical user interface (GUI) 180. GUI 180 is generally operable to tailor and filter data entered by and presented to user 125. GUI 180 may provide user 125 with an efficient and user-friendly presentation of a user profile 166, including security and/or incentive program parameters associated with user profiles 166 or user 125. GUI 180 may comprise a plurality of displays having interactive fields, pull-down lists, and buttons operated by user 125. GUI 180 may include multiple levels of abstraction including groupings and boundaries. The term GUI 180 may be used in the singular or in the plural to describe one or more GUIs 180 and each of the displays of a particular GUI 180.

In some embodiments, network storage device 130 may refer to any suitable device communicatively coupled to network 135 and capable of storing and facilitating retrieval of data and/or instructions. Examples of network storage device 130 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Network storage device 130 may store any data and/or instructions utilized by server 115.

In certain embodiments, network 135 may refer to any interconnecting system capable of transmitting audio, video, signals, data, messages, or any combination of the preceding. Network 135 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In operation, application 162, upon execution by processor 155, facilitates incentivizing user 125 to engage in secure transactions. User profile 166 of user 125 may associate particular security parameters with user 125 and may link user 125 with a particular incentive program 164. Application 162 may receive transaction information 190 from transaction source 105. Transaction information 190 may include transaction number, account number, originating party identifier, beneficiary party identifier, transaction date, transaction location, transaction method, transaction type, dollar amount, security indicator that indicates whether point of sale security measures were used, and/or other suitable information. Although FIG. 1 illustrates transaction source 105 as external to enterprise 110, transaction source 105 may be internal or external to enterprise 110, depending on particular implementations.

In particular embodiments, application 162 may be operable to determine a security level associated with a transaction based at least in part on transaction information 190 and security information stored in user profile 166. For example, application 162 may determine, based on transaction information 190, that a transaction included a personal identification number entered by user 125 at point of sale. Application 162 may associate use of a personal identification number at point of sale with a high security level. Thus, the transaction may earn user 125 incentive points in accordance with a high security level. The number of incentive points may depend on a security level associated with the particular security measure involved in the transaction. In some embodiments, incentive points for some point of sale security measures may be higher than others. In some embodiments, administrator 150 may associate security levels with certain security features or groups of security features.

As another example, application 162 may determine, based on transaction information 190, that no particular security measure is associated with a transaction. However, application 162 may determine that user 125 is still eligible to receive incentive points on the transaction because user profile 166 associated with user 125 indicates that user 125 has agreed to certain security measures or a certain security profile. For example, user 125 may configure authorization controls in user profile 166 that prevents authorization of any transactions from certain merchants or a class of merchants. In exchange for configuring such detailed authorization controls, user 125 may be eligible to receive incentive points on all transactions.

FIG. 2 illustrates an example user interface 200 for configuring a security profile, according to a particular embodiment. User profile 166 may include secure transaction parameters associated with a consumer, such as user 125. In particular embodiments, user 125 may use an interface such as user interface 200 to configure security parameters associated with an account of user 125. User interface 200 may also facilitate user 125 linking security parameters with an incentive program 164. User interface 200 may include authorization controls such as restricted transactions list 210, travel advisory list 218, and various radio buttons 226-232 for enabling/disabling particular security features. User interface 200 may include incentive program selection box 234. In particular embodiments, user interface 200 may include any suitable user interface for configuring and/or displaying security parameters.

Restricted transaction list 210 provides an interface for user 125 to decline transaction authorization based on a particular merchant or merchant category, budget amount, transaction velocity (e.g., number of transactions over a given period), transaction amount, time of day, geography, method of payment (e.g., online), or any other suitable criteria for authorizing transactions. In one example, restricted transaction list 210 includes box 212 for merchant or merchant category, box 214 for restricted time, box 216 for number of transactions, and box 217 for maximum amount.

As a particular example, user 125 may not drink alcohol and therefore user 125 never shops at liquor stores. To prevent fraudulent transactions, user 125 may decline transaction authorization for a merchant category comprising all liquor stores by selecting liquor store in box 212 and specifying a time period of “never allow” in box 214.

As another particular example, user 125 may gamble at casinos, but only during a particular basketball tournament held every year in March. To prevent fraudulent transactions, user 125 may decline transaction authorization for a merchant category comprising casinos by selecting casino in box 212. User 125 may specify a time period of March 15 through March 31 when casino transactions may be authorized. User 125 may specify in box 216 that a number of casino transactions during the time period may be unlimited, but specify in box 217 that a maximum transaction amount over the time period is limited to $2,000.

As another particular example, user 125 may restrict transactions at a particular merchant. If user 125 rarely shops at department store X, user 125 may want to restrict some or all transactions at department store X. User 125 may also configure exceptions. As an example, user 125 may configure a particular day, such as the birthday of the spouse of user 125, when user 125 may decide to make one transaction at department store X up to a configured amount, such as $800 toward a birthday gift for user 125's spouse. To prevent fraudulent transactions, user 125 may select department store X in box 212, enter a date of (e.g., August 29) in box 214, limit a number of transactions to one in box 216, and limit a transaction amount to $800 in box 217.

Travel advisory list 218 provides a user interface for user 125 to specify upcoming travel dates. A transaction outside of the home geography of user 125 may trigger a suspicious activity alert. User 125 may enter travel plans in advance of travel to prevent triggering suspicious activity alerts. Any other transactions outside of the home geography of user 125 and not within the specified travel date and geography may be declined. In particular embodiments, travel advisory list 218 may include box 220 for specifying a travel location, box 222 for specifying travel dates, and box 224 for specifying a travel purpose (e.g., business, vacation, etc.).

For example, user 125 may have an upcoming business trip to New York at the beginning of the year. To prevent fraudulent transactions throughout the year, transactions originating in New York may normally be declined. However, user 125 may specify New York in box 220, Jan. 10-15, 2014 in box 222, and business in box 224 to permit transactions while user 125 is on a business trip in New York.

In particular embodiments, radio box 226 provides a user interface for user 125 to allow or disallow all online transactions. Radio box 228 provides a user interface for user 125 to enable or disable ShopSafe functionality for all online transactions. In general, ShopSafe functionality generates a temporary account number that links directly to user 125's real account number. User 125 can use the temporary account number to access funds in the real account instead of using the real account number. Thus, the real account number remains private and secure. Radio box 230 provides a user interface for user 125 to enable or disable use of personal identification numbers for all retail transactions. Radio box 232 provides a user interface for user 125 to allow or disallow all unattended transactions.

Incentive program selection box 234 provides a user interface for user 125 to link use of security features to an incentive program, such as incentive program 164. In particular embodiments, user 125 may apply rewards earned through using certain security features to an existing reward program that user 125 may be enrolled in, such as an airline points reward program. User 125 may apply rewards earned through using certain security features to an incentive program designed solely to reward user 125 for responsible and secure behavior. In particular embodiments, incentives earned for using certain security features may be applied to any suitable incentive program in any suitable manner.

In some embodiments, user interface 200 may display a reward associated with enabling a security feature or combination of security features. Displaying the reward may encourage user 125 to enable a greater number of security features and/or to enable they types of security features associated with a higher likelihood of mitigating risk.

Although example user interface components are described above, one of skill in the art will recognize other user interface components applicable to particular embodiments. For example, radio buttons illustrated as specifying global security options for all transactions may also specify the same option for a particular transaction, group of transactions, or class of transactions. Similarly, options illustrated as applying to a particular transaction, group of transactions, or class of transactions may also apply at a global level.

FIG. 3 illustrates an example flowchart of a method 300 for incentivizing secure transactions. In particular embodiments, one or more steps of method 300 may be performed by components of system 100 of FIG. 1.

The method begins at step 310. At step 312, application 162 receives transaction information 190 from transaction source 105. Among other details, transaction information 190 may include account number, originating party identifier, beneficiary party identifier, transaction date, transaction location, transaction method, transaction type, dollar amount, and/or a security indicator that indicates whether point of sale security measures were used.

As an example, a consumer, such as user 125, may have purchased a television online from OnlineElectronicsSuperstore using a credit card. User 125 may have used ShopSafe (e.g., a service that allows a user to keep a credit card number private by creating a temporary card number each time the user makes an online purchase) to purchase the television. Transaction information 190 may indicate that user 125 purchased a television online for $600 from OnlineElectronicsSuperstore located in New York and that user 125 used a temporary credit card number.

At step 314, application 162 may determine a security level associated with the transaction. Application 162 may use any suitable combination of information in transaction information 190, user profiles 166, and/or incentive programs 164 to determine the security level.

In some embodiments, application 162 may evaluate threshold criteria to determine whether further processing is needed. For example, application 162 may evaluate a transaction amount in transaction information 190 to determine whether further processing is needed. For small transaction amounts, application 162 may not determine a security level for the transaction. Alternatively, in some embodiments, application 162 may determine a security level for a transaction of any amount.

In some embodiments, application 162 may access user profile 166 associated with an originating party identifier or benefitting party identifier in transaction information 190. User profile 166 may indicate whether the consumer identified in transaction information 190 is subscribed to an incentive program and/or whether the consumer has configured security parameters as part of a security profile. Application 162 may assign as security level to the transaction based on any combination of the above information.

As an example, application 162 may assign a high security level to the transaction of user 125 who purchased the television from OnlineElectronicsSuperstore because user 125 used ShopSafe with the transaction. If user 125 had not used ShopSafe, application 162 may assign a low security level to the transaction.

At step 316, application 162 determines whether the consumer is associated with an incentive plan. In some embodiments, application 162 may access user profile 166 associated with an originating party identifier or benefitting party identifier in transaction information 190 to determine whether the consumer identified in transaction information 190 is subscribed to an incentive program. If the consumer is not subscribed to an incentive program, method 300 may return to step 310 and wait to receive additional transaction information 190. If the consumer is subscribed to an incentive program, method 300 may continue to step 318.

At step 318, application 162 may determine a reward value based on the security level determined at step 314. In some embodiments, application 162 may determine the reward value based on any suitable combination of information in transaction information 190, user profiles 166, and/or incentive programs 164.

In some embodiments, application 162 may determine a reward value based on a per-transaction incentive program. In a per-transaction incentive program, a consumer, such as user 125, may not be required to agree to any particular security measures in advance. User 125 may earn points on transactions where user 125 chooses to use security measures and user 125 may not earn points on transactions where user 125 chooses not to use security measures. The particular number of points earned may depend on the security level associated with the security measure used with the transaction. Generally, security measures with a higher security level may be associated with a higher reward value.

As an example, user 125 who purchased the television from OnlineElectronicsSuperstore may subscribe to a security based incentive program where user 125 earns points for transactions that use certain security measures. The security based incentive program may reward user 125 with five points for high security level secure transactions, two points for medium security level transactions, and zero points for low security level or unsecured transactions. Because user 125 purchased the television using ShopSafe, which was determined to be a high security level transaction, user 125 may earn five points.

In some embodiments, application 162 may determine a reward value based on a consumers participation in a security incentive program. In such a program, user 125 may agree to use certain security measures for all applicable transactions. User 125 may be required to specify certain authorization controls in a security profile. In exchange for participation in the incentive program, user 125 may receive points on all transactions, regardless of whether a particular transaction included a security measure. In some embodiments, application 162 may determine a higher or lower reward value on a particular transaction depending on the security level assigned to the transaction.

As an example, user 125 who purchased the television from OnlineElectronicsSuperstore may subscribe to a security based incentive program where user 125 agrees to use ShopSafe for all online transactions. Because user 125 has agreed to use ShopSafe on all online transactions, user 125 may receive reward points on all transactions, even in-person transactions (or other non-online transactions) that do not use ShopSafe. In some embodiments, application 162 may determine that transactions using ShopSafe earn a five point reward value and all other transactions earn a two point reward value.

As another example, user 125 may accrue certain rewards (such as a number of points or a points multiplier) on all transactions for as long as the user's profile prohibits transactions with high risk merchant categories. Examples of high risk merchant categories may include liquor stores, casinos, or quasi cash merchants (e.g., merchants that charge user 125's credit card account in exchange for money orders, travelers checks, foreign currency, lottery tickets, casino chips or gambling wagers, cash vouchers, etc.).

As another example, user 125 may accrue certain rewards (such as a number of points or a points multiplier) on all transactions for as long as the user's profile prohibits transactions with high risk transaction categories. Examples of high risk transaction categories may include online, over the phone, or unattended transactions.

In some embodiments, application 162 may determine a reward value based on a consumers participation in a non-security incentive program, such as an airline points rewards program. Application 162 may apply a security multiplier when determining a reward value.

As an example, user 125 who purchased the television from OnlineElectronicsSuperstore may subscribe to an airline points program. User 125 may have earned 600 points for the purchase of the television under the normal conditions of the airline points program. Because user 125 used ShopSafe to purchase the television, application 162 may determine that user 125 has earned a reward value multiplier of three times the initial point value. User 125 may thus earn 1800 points.

At step 320, application 162 increments the reward balance of the incentive program identified at step 316 with the reward value determined at step 318. After step 320, application 162 may return to step 310 and wait to receive additional transaction information 190. Modifications, additions, or omissions may be made to method 300. Additionally, one or more steps in method 300 of FIG. 3 may be performed in parallel or in any suitable order.

FIG. 4 illustrates example flowchart of a method 400 for incentivizing secure transactions, according to a particular embodiment. Method 400 begins at step 404 where processor(s) 155 receives account information associated with a financial account via an interface. The financial account corresponds to a consumer (e.g., user 125). The account information may comprise transaction information and/or user profile information associated with the financial account.

Transaction information may include transaction number, account number, originating party identifier, beneficiary party identifier, transaction date, transaction location, transaction method (e.g., bank branch, ATM, online, wire, cash, etc.), transaction type (e.g., deposit, withdrawal, transfer), dollar amount, report indicator that indicates whether or not a report was filed on the transaction, security indicator that indicates whether point of sale security measures were used (e.g., personal identification number, temporary or one-time account identifier), and/or other suitable information.

User profile information may describe security measures that the consumer enables for the financial account in a user profile. Processor(s) 155 may receive user profile information at any suitable time. For example, processor(s) may receive user profile information via an interface when the consumer updates the user profile. As another example, processor(s) 155 may receive user profile information in conjunction with a transaction (e.g., when determining a reward to apply to a transaction, processor(s) 155 may retrieve user profile information from memory 160 and/or storage 130 via an interface).

At step 408, one or more processors 115 determine, based on the account information, that the consumer invoked one or more security features for the financial account. In some embodiments, transaction information received at step 404 may indicate that the consumer invoked one or more security features as a part of a transaction transacted via the financial account. As an example, the transaction information may indicate that the consumer entered a personal identification number (PIN) as part of the transaction. As another example, the transaction information may indicate that the consumer used a temporary account number for the transaction (e.g., using ShopSafe). The temporary account number links to the financial account while keeping the real account number private. As yet another example, the transaction information may indicate that the transaction satisfies certain low-risk criteria based on the dollar amount, location, time of day, merchant category, and/or other factors.

In some embodiments, user profile information received at step 404 may indicate security features that the consumer enables in user profile 166. As examples, the consumer may enable alerts and/or prohibit transactions involving high risk merchant categories (e.g., casinos, liquor stores, quasi-cash merchants), high dollar amounts, high frequency (e.g., more than X transactions per day), high risk transaction channels (e.g., online transactions could be considered high risk), or high risk locations (e.g., locations outside of the consumer's residential area, business area, or planned travel area).

At step 412, processor(s) 155 determine a reward based on the security features that the consumer invoked for the financial account. In some embodiments, the reward could be a number (n) of points. For example, if the consumer enables security features in the user profile, the consumer may get a reward of 1,000 points. Or, the user may get a reward of 1 point per transaction for as long as the security features are enabled in the user profile. Or, the user may get a reward of 2 point for each transaction that uses a PIN, a temporary account number (e.g., ShopSafe), or other transaction level security feature. In some embodiments, the reward could be a points multiplier, such as double points or triple points. As an example, a transaction may ordinarily be entitled to 3 points based on the dollar amount of the transaction or other criteria defined by the incentive program. If the reward for invoking the security features corresponds to a points multiplier of 2, the transaction would receive 6 points (3 base points×2 points multiplier). Other examples of rewards could include cash back programs or other discounts, lowered interest rate applied to the consumer's account balance, or any suitable combination of rewards.

In some embodiments, processor(s) 155 determine a level of risk mitigation based on a number and type of security features invoked by the consumer and determine the reward according to the level of risk mitigation. For example, a consumer that enables a higher density of alerts may realize a higher level of risk mitigation and, thus, would be entitled to greater reward (e.g., more points, higher points multiplier, bigger discount, lower interest rate, etc.) As another example, a consumer that disallows transactions with high risk merchant categories may realize a higher level of risk mitigation than a consumer that only enables an alert when transactions with the high risk merchant categories exceed a pre-determined frequency. The consumer that disallows such transactions may be entitled to a greater reward. Thus, processor(s) 155 can analyze the combination of security features invoked by the consumer to yield a reward that correlates to the level of risk mitigation.

At step 416, processor(s) 155 apply the reward to the financial account. The rewards can be applied when the consumer enables the security features in the user profile, when the consumer transacts a transaction while the security features are enabled in the user profile, when the consumer transacts a transaction using a security feature (such as a PIN or ShopSafe), or any suitable combination of the preceding. To apply the reward to the financial account, processor(s) 155 may correlate the financial account to an incentive program based on the consumer's user profile and apply the reward to the incentive program. If the consumer subscribes to multiple incentive programs, processor(s) 155 can select to apply the reward to each incentive program that qualifies for the reward, to a preferred incentive program selected by the consumer (e.g., according to the user profile), or to the incentive program that is entitled to the greatest reward for the particular transaction. If the consumer does not have an incentive program in place, in some embodiments, processor(s) 155 can open an incentive plan for the consumer or hold the reward on the consumer's behalf for a period of time during which the consumer can enroll in an incentive program. The method then ends.

Certain embodiments of the present disclosure may provide one or more technical advantages. A technical advantage of one embodiment includes reducing an amount of computing resources used for fraud detection. Encouraging a consumer to be security conscious may reduce a need to track consumer patterns to predict potentially fraudulent transactions. For example, a fraud detection system may no longer need to expend resources to track a consumer's purchasing habits if the consumer is incentivized to create authorization controls and travel updates that describe the consumers purchasing habits. Another technical advantage of an embodiment includes increased accuracy in fraud detection through a consumer's proactive indication of spending patterns. For example, authorization controls and travel updates submitted by a user may be more accurate than predictions based on past behavior of the consumer. Certain embodiments of the present disclosure may include some, all, or none of the above advantages. One or more other technical advantages may be readily apparent to those skilled in the art from the figures, descriptions, and claims included herein.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described in detail, it should be understood that various changes, substitutions, and alterations can be made hereto without departing from the scope of the invention as defined by the appended claims.

What is claimed is:

1. A system comprising:
an interface operable to receive account information associated with a financial account, wherein the financial account corresponds to a consumer; and
one or more processors communicatively coupled to the interface, the one or more processors operable to:
determine, based on the account information, that the consumer invoked one or more security features for the financial account;
determine a reward based on the security features that the consumer invoked for the financial account; and
apply the reward to the financial account.

2. The system of claim 1, wherein the account information comprises transaction information indicating that the consumer invoked at least one of the security features as a part of a transaction transacted via the financial account.

3. The system of claim 2, wherein the transaction information comprises an indication that the consumer entered a personal identification number as part of the transaction.

4. The system of claim 1, wherein the account information comprises user profile information associated with the consumer.

5. The system of claim 4, wherein the user profile information indicates that the consumer has prohibited transactions involving an unauthorized category of merchants.

6. The system of claim 4, wherein the user profile information indicates that the consumer has prohibited transactions involving an unauthorized class of transactions.

7. The system of claim 1, the one or more processors further operable to:
determine a level of risk mitigation based on a number and type of security features invoked by the consumer; and
determine the reward according to the level of risk mitigation.

8. Non-transitory computer readable medium comprising logic, the logic, when executed by a processor, operable to:
receive account information associated with a financial account, wherein the financial account corresponds to a consumer;
determine, based on the account information, that the consumer invoked one or more security features for the financial account;
determine a reward based on the security features that the consumer invoked for the financial account; and
apply the reward to the financial account.

9. The computer readable medium of claim 8, wherein the account information comprises transaction information indicating that the consumer invoked at least one of the security features as a part of a transaction transacted via the financial account.

10. The computer readable medium of claim 9, wherein the transaction information comprises an indication that the consumer entered a personal identification number as part of the transaction.

11. The computer readable medium of claim 8, wherein the account information comprises user profile information associated with the consumer.

12. The computer readable medium of claim 11, wherein the user profile information indicates that the consumer has prohibited transactions involving an unauthorized category of merchants.

13. The computer readable medium of claim 11, wherein the user profile information indicates that the consumer has prohibited transactions involving an unauthorized class of transactions.

14. The computer readable medium of claim 8, wherein the logic is further operable to:
determine a level of risk mitigation based on a number and type of security features invoked by the consumer; and
determine the reward according to the level of risk mitigation.

15. A method, comprising:
receiving account information associated with a financial account, wherein the financial account corresponds to a consumer;
determining, based on the account information, that the consumer invoked one or more security features for the financial account;
determining a reward based on the security features that the consumer invoked for the financial account; and
applying the reward to the financial account.

16. The method of claim 15, wherein the account information comprises transaction information indicating that the consumer invoked at least one of the security features as a part of a transaction transacted via the financial account.

17. The method of claim 16, wherein the transaction information comprises an indication that the consumer entered a personal identification number as part of the transaction.

18. The method of claim 15, wherein the account information comprises user profile information associated with the consumer.

19. The method of claim 18, wherein the user profile information indicates that the consumer has prohibited transactions involving an unauthorized category of merchants.

20. The method of claim 18, wherein the user profile information indicates that the consumer has prohibited transactions involving an unauthorized class of transactions.

21. The method of claim 15, further comprising:
determining a level of risk mitigation based on a number and type of security features invoked by the consumer; and
determining the reward according to the level of risk mitigation.
